(19) United States
(12) Patent Application Publication
(10) Pub. No.: US 2026/0212346 A1
(43) Pub. Date: Jul. 23, 2026

(54) System, Method, and Computer Program Product for Automatically Updating Credentials

(71) Applicant: Visa International Service Association, San Francisco, CA (US)

(72) Inventors: Burnnet Tai Lung Or, Surrey Hills (AU); Hollie Dee Buchanan, Kew (AU); Nathanael Eduard Posumah, Singapore (SG)

(21) Appl. No.: 19/158,152

(22) PCT Filed: Feb. 23, 2024
(86) PCT No.: PCT/US24/16985

§ 371 Date: Aug. 20, 2025

Related U.S. Application Data
(60) Provisional application No. 63/447,717, filed on Feb. 23, 2023.

(51) Int. Cl. G06Q 20/38

(52) U.S. Cl. CPC G06Q 20/3821

(57) ABSTRACT

Provided is a system, method, and computer program product for automatically updating credentials. The system includes at least one processor programmed or configured to receive, from a first issuer system, a migration request identifying an original account identifier, a new account identifier, and a credential request history associated with the original account identifier, analyze the credential request history to identify at least one provisioned credential associated with the original account identifier, the at least one provisioned credential including at least one of a card-on-file merchant credential and a device token, and in response to identifying the at least one provisioned credential, automatically generate an update request configured to cause at least one of the following to update the at least one provisioned credential based on the new account identifier: a merchant system, a payment gateway associated with a merchant system, a user device, or any combination thereof.

### CROSS REFERENCE TO RELATED APPLICATIONS

This application is the United States national phase of International Application No. PCT/US24/16985, filed on Feb. 23, 2024, and claims the benefit of U.S. Provisional Ser. No. 63/447,717 , filed on Feb. 23, 2023, the disclosures of which are hereby incorporated by reference in their entireties.

### BACKGROUND

### 1. Technical Field

This disclosure relates generally to credentials and, in some non-limiting embodiments or aspects, to systems, methods, and computer program products for automatically updating credentials.

### 2. Technical Considerations

When payment card issuers migrate from one scheme (e.g., payment network) to another, the process involves a re-issue of all their cards under the portfolio to be migrated, which will result in the cardholder receiving a new card from one scheme replacing the old card from the other scheme. As usage increases on device-based credentials and card-on-file credentials, these scheme migrations become more difficult and complex because they require the card holder to both manually delete and reprovision tokens on devices and contact each card-on-file merchant to change their card details. Failing to do so will result in transactions getting declined. Moreover, the existing processes used to change credentials use numerous communications, messages, and duplicate requests and/or queries, resulting in wasted computing/processing resources and additional opportunities for security breaches.

### SUMMARY

According to non-limiting embodiments or aspects, provided is a system comprising at least one processor of a transaction processing system, the at least one processor programmed or configured to: receive, from a first issuer system, a migration request identifying an original account identifier, a new account identifier, and a credential request history associated with the original account identifier, the original account identifier associated with a second transaction processing system; analyze the credential request history to identify at least one provisioned credential associated with the original account identifier, the at least one provisioned credential comprising at least one of a card-on-file merchant credential and a device token; and in response to identifying the at least one provisioned credential, automatically generate an update request configured to cause at least one of the following to update the at least one provisioned credential based on the new account identifier: a merchant system, a payment gateway associated with a merchant system, a user device, or any combination thereof.

In non-limiting embodiments or aspects, the at least one provisioned credential associated with the original account identifier comprises the at least one of a card-on-file merchant credential and the device token. In non-limiting embodiments or aspects, the card-on-file merchant credential comprises the original account identifier. In non-limiting embodiments or aspects, the migration request is received via a central migration system in communication with the first issuer system, the transaction processing system, and the second transaction processing system, and wherein at least the credential request history is received by the central migration system from the first issuer system. In non-limiting embodiments or aspects, the credential request history comprises at least one of the following: a token reference identifier, token requestor data, a merchant identifier associated with the original account identifier, or any combination thereof. In non-limiting embodiments or aspects, wherein account data associated with the at least one device token comprises a new token. In non-limiting embodiments or aspects, account data associated with the at least one provisioned credential comprises at least one of the following: a subset of digits of the new account identifier, a token corresponding to the new account identifier, the new account identifier, or any combination thereof. In non-limiting embodiments or aspects, the at least one provisioned credential associated with the original account identifier comprises the at least one of a card-on-file merchant credential and the device token, and automatically generating the update request in response to identifying the at least one provisioned credential comprises: in response to identifying card-on-file merchant credential, automatically generating a merchant update request configured to cause the merchant system for the card-on-file merchant and/or the payment gateway for the card-on-file merchant to update account data associated with the provisioned credential and stored by the merchant system or the payment gateway of the card-on-file merchant; and in response to identifying the device token, automatically generating a device update request configured to cause a user device to update account data associated with the device token and stored by the user device.

According to non-limiting embodiments or aspects, provided is a computer-implemented method comprising: receiving, with at least one processor of a transaction processing system from a first issuer system, a migration request identifying an original account identifier, a new account identifier, and a credential request history associated with the original account identifier, the original account identifier associated with a second transaction processing system; analyzing, with the at least one processor, the credential request history to identify at least one provisioned credential associated with the original account identifier, the at least one provisioned credential comprising at least one of a card-on-file merchant credential and a device token; and in response to identifying the at least one provisioned credential, automatically generating an update request configured to cause at least one of the following to update the at least one provisioned credential based on the new account identifier: a merchant system, a payment gateway associated with a merchant system, a user device, or any combination thereof.

In non-limiting embodiments or aspects, the at least one provisioned credential associated with the original account identifier comprises the at least one of a card-on-file merchant credential and the device token. In non-limiting embodiments or aspects, the card-on-file merchant credential comprises the original account identifier. In non-limiting embodiments or aspects, the migration request is received via a central migration system in communication with the first issuer system, the transaction processing system, and the second transaction processing system, and wherein at least the credential request history is received by the central migration system from the first issuer system. In non-limiting embodiments or aspects, the credential request history comprises at least one of the following: a token reference identifier, token requestor data, a merchant identifier associated with the original account identifier, or any combination thereof. In non-limiting embodiments or aspects, wherein account data associated with the at least one device token comprises a new token. In non-limiting embodiments or aspects, account data associated with the at least one provisioned credential comprises at least one of the following: a subset of digits of the new account identifier, a token corresponding to the new account identifier, the new account identifier, or any combination thereof. In non-limiting embodiments or aspects, the at least one provisioned credential associated with the original account identifier comprises the at least one of a card-on-file merchant credential and the device token, and automatically generating the update request in response to identifying the at least one provisioned credential comprises: in response to identifying the card-on-file merchant credential, automatically generating a merchant update request configured to cause the merchant system or payment gateway associated with the card-on-file merchant to update account data associated with the provisioned credential and stored by the merchant system or payment gateway of the card-on-file merchant; and in response to identifying the device token, automatically generating a device update request configured to cause a user device to update account data associated with the device token and stored by the user device.

According to non-limiting embodiments or aspects, provided is a computer-implemented method comprising: receiving, with at least one processor of a transaction processing system from a first issuer system, a migration request identifying an original account identifier, a new account identifier, and a credential request history associated with the original account identifier, the original account identifier associated with a second transaction processing system; analyzing, with the at least one processor, the credential request history to identify at least one provisioned credential of a card-on-file merchant and at least one device token associated with the original account identifier; in response to identifying the provisioned credential of at least one card-on-file merchant, automatically generating a merchant update request configured to cause the card-on-file merchant to update account data associated with the provisioned credential and stored by a merchant system of the card-on-file merchant; and in response to identifying the at least one device token, automatically generating a device update request configured to cause a user device to update account data associated with the at least one device token and stored by the user device.

According to non-limiting embodiments or aspects, provided is a computer program product comprising at least one non-transitory computer-readable medium including program instructions that, when executed by at least one processor of a transaction processing system, causes the at least one processor to: receive, from a first issuer system, a migration request identifying an original account identifier, a new account identifier, and a credential request history associated with the original account identifier, the original account identifier associated with a second transaction processing system; analyze the credential request history to identify at least one provisioned credential associated with the original account identifier, the at least one provisioned credential comprising at least one of a card-on-file merchant credential and a device token; and in response to identifying the at least one provisioned credential, automatically generate an update request configured to cause at least one of the following to update the at least one provisioned credential based on the new account identifier: a merchant system, a payment gateway associated with a merchant system, a user device, or any combination thereof.

Other non-limiting embodiments or aspects will be set forth in the following numbered clauses:

Clause 1: A system comprising at least one processor of a transaction processing system, the at least one processor programmed or configured to: receive, from a first issuer system, a migration request identifying an original account identifier, a new account identifier, and a credential request history associated with the original account identifier, the original account identifier associated with a second transaction processing system; analyze the credential request history to identify at least one provisioned credential associated with the original account identifier, the at least one provisioned credential comprising at least one of a card-on-file merchant credential and a device token; and in response to identifying the at least one provisioned credential, automatically generate an update request configured to cause at least one of the following to update the at least one provisioned credential based on the new account identifier: a merchant system, a payment gateway associated with a merchant system, a user device, or any combination thereof.

Clause 2: The system of clause 1, wherein the at least one provisioned credential associated with the original account identifier comprises the at least one of a card-on-file merchant credential and the device token.

Clause 3: The system of clause 1 or 2, wherein the card-on-file merchant credential comprises the original account identifier.

Clause 4: The system of any of clauses 1-3, wherein the migration request is received via a central migration system in communication with the first issuer system, the transaction processing system, and the second transaction processing system, and wherein at least the credential request history is received by the central migration system from the first issuer system.

Clause 5: The system of any of clauses 1-4, wherein the credential request history comprises at least one of the following: a token reference identifier, token requestor data, a merchant identifier associated with the original account identifier, or any combination thereof.

Clause 6: The system of any of clauses 1-5, wherein account data associated with the at least one device token comprises a new token.

Clause 7: The system of any of clauses 1-6, wherein account data associated with the at least one provisioned credential comprises at least one of the following: a subset of digits of the new account identifier, a token corresponding to the new account identifier, the new account identifier, or any combination thereof.

Clause 8: The system of any of clauses 1-7, wherein the at least one provisioned credential associated with the original account identifier comprises the at least one of a card-on-file merchant credential and the device token, and wherein automatically generating the update request in response to identifying the at least one provisioned credential comprises: in response to identifying card-on-file merchant credential, automatically generating a merchant update request configured to cause the merchant system for the card-on-file merchant and/or the payment gateway for the card-on-file merchant to update account data associated with the provisioned credential and stored by the merchant system or the payment gateway of the card-on-file merchant; and in response to identifying the device token, automatically generating a device update request configured to cause a user device to update account data associated with the device token and stored by the user device.

Clause 9: A computer-implemented method comprising: receiving, with at least one processor of a transaction processing system from a first issuer system, a migration request identifying an original account identifier, a new account identifier, and a credential request history associated with the original account identifier, the original account identifier associated with a second transaction processing system; analyzing, with the at least one processor, the credential request history to identify at least one provisioned credential associated with the original account identifier, the at least one provisioned credential comprising at least one of a card-on-file merchant credential and a device token; and in response to identifying the at least one provisioned credential, automatically generating an update request configured to cause at least one of the following to update the at least one provisioned credential based on the new account identifier: a merchant system, a payment gateway associated with a merchant system, a user device, or any combination thereof.

Clause 10: The computer-implemented method of clause 9, wherein the at least one provisioned credential associated with the original account identifier comprises the at least one of a card-on-file merchant credential and the device token.

Clause 11: The computer-implemented method of clause 9 or 10, wherein the card-on-file merchant credential comprises the original account identifier.

Clause 12: The computer-implemented method of any of clauses 9-11, wherein the migration request is received via a central migration system in communication with the first issuer system, the transaction processing system, and the second transaction processing system, and wherein at least the credential request history is received by the central migration system from the first issuer system.

Clause 13: The computer-implemented method of any of clauses 9-12, wherein the credential request history comprises at least one of the following: a token reference identifier, token requestor data, a merchant identifier associated with the original account identifier, or any combination thereof.

Clause 14: The computer-implemented method of any of clauses 9-13, wherein account data associated with the at least one device token comprises a new token.

Clause 15: The computer-implemented method of any of clauses 9-14, wherein account data associated with the at least one provisioned credential comprises at least one of the following: a subset of digits of the new account identifier, a token corresponding to the new account identifier, the new account identifier, or any combination thereof.

Clause 16: The computer-implemented method of any of clauses 9-15, wherein the at least one provisioned credential associated with the original account identifier comprises the at least one of a card-on-file merchant credential and the device token, and wherein automatically generating the update request in response to identifying the at least one provisioned credential comprises: in response to identifying the card-on-file merchant credential, automatically generating a merchant update request configured to cause the merchant system or payment gateway associated with the card-on-file merchant to update account data associated with the provisioned credential and stored by the merchant system or payment gateway of the card-on-file merchant; and in response to identifying the device token, automatically generating a device update request configured to cause a user device to update account data associated with the device token and stored by the user device.

Clause 17: A computer-implemented method comprising: receiving, with at least one processor of a transaction processing system from a first issuer system, a migration request identifying an original account identifier, a new account identifier, and a credential request history associated with the original account identifier, the original account identifier associated with a second transaction processing system; analyzing, with the at least one processor, the credential request history to identify at least one provisioned credential of a card-on-file merchant and at least one device token associated with the original account identifier; in response to identifying the provisioned credential of at least one card-on-file merchant, automatically generating a merchant update request configured to cause the card-on-file merchant to update account data associated with the provisioned credential and stored by a merchant system of the card-on-file merchant; and in response to identifying the at least one device token, automatically generating a device update request configured to cause a user device to update account data associated with the at least one device token and stored by the user device.

Clause 18: A computer program product comprising at least one non-transitory computer-readable medium including program instructions that, when executed by at least one processor of a transaction processing system, causes the at least one processor to: receive, from a first issuer system, a migration request identifying an original account identifier, a new account identifier, and a credential request history associated with the original account identifier, the original account identifier associated with a second transaction processing system; analyze the credential request history to identify at least one provisioned credential associated with the original account identifier, the at least one provisioned credential comprising at least one of a card-on-file merchant credential and a device token; and in response to identifying the at least one provisioned credential, automatically generate an update request configured to cause at least one of the following to update the at least one provisioned credential based on the new account identifier: a merchant system, a payment gateway associated with a merchant system, a user device, or any combination thereof.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for automatically updating credentials according to some non-limiting embodiments or aspects;

FIG. 2 is a flow diagram of a method for automatically updating credentials according to some non-limiting embodiments or aspects;

FIG. 3 is a further schematic diagram of a system for automatically updating credentials according to some non-limiting embodiments or aspects;

FIG. 4 is a further schematic diagram of a system for automatically updating credentials according to some non-limiting embodiments or aspects;

FIG. 5 is a schematic diagram of an electronic payment processing network according to some non-limiting embodiments or aspects; and FIG. 6 is a schematic diagram of example components of one or more devices according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings and appendix, and described in the following specification, are simply exemplary embodiments or aspects of the disclosed subject matter. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

An “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, etc.).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers programmed or configured to process online payment transactions through webpages, mobile applications, and/or the like.

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more POS devices used by a merchant, one or more acquirer host computers used by an acquirer, one or more mobile devices used by a user, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “payment device” may refer to an electronic payment device, a portable financial device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a personal digital assistant (PDA), a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of payment devices managed by a transaction service provider. As used herein, the term “payment gateway system” may refer to one or more computer systems, computer devices, servers, groups of servers, and/or the like, operated by or on behalf of a payment gateway.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

Non-limiting embodiments or aspects of the disclosed subject matter are directed to systems, methods, and computer program products for automatically updating credentials that improve upon existing credential-updating methods. In non-limiting embodiments, a user does not have to engage in extra steps to update credentials (e.g., such as payment credentials, including account identifiers and tokens) for payment applications or providers (e.g., merchants, electronic wallets, and/or the like).

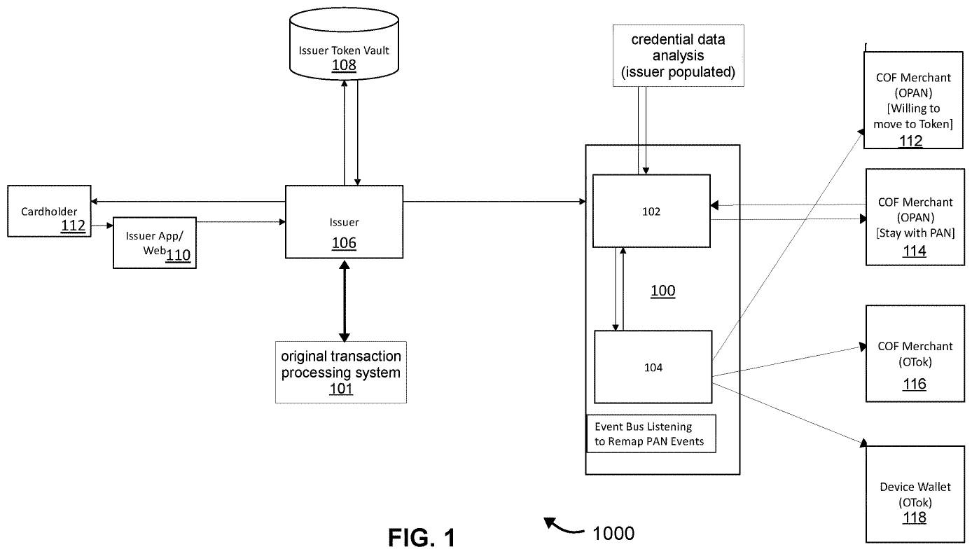

Referring to FIG. 1, shown is a system 1000 for automatically updating credentials according to some non-limiting embodiments or aspects. A transaction processing system 100 includes a digital credential updating service 102 and a token management system 104. The digital credential updating service 102 may include software and/or hardware, such as a server computer executing one or more software applications as a service. The token management system 104 may include software and/or hardware, such as a server computer executing one or more applications as a service, an application executed by the transaction processing system, and/or the like. The token management system 104 may manage (e.g., issue, store, maintain, etc.) tokens to merchants (e.g., merchant tokens) and/or devices (e.g., device tokens for user devices).

The transaction processing system 100 may be in communication with an issuer system 106 that includes and/or is in communication with an issuer token vault 108. The issuer token vault 108 may include software and/or hardware, such as a network-accessible data storage device and/or associated software application(s) for storing and/or retrieving one or more tokens issued by an issuer corresponding to an issuer system 106. The issuer system 106 may be in communication with a cardholder 112 directly and/or through an application 110 (e.g., a mobile application, a website, and/or the like). In the depicted example, the issuer system 106 may be switching from a first transaction processing system 101 (e.g., an original transaction processing system) to a second transaction processing system 100 (e.g., a target transaction processing system). In such an example, the issuer system 106 may generate a new PAN and issue a new payment device based on the new PAN.

With continued reference to FIG. 1, the issuer system 106 may transmit a migration request to the transaction processing system 100 that includes the original PAN (e.g., associated with the first transaction processing system), the new PAN, and a credential request history. The credential request history may be generated based on querying an issuer token vault 108, and may include a list of all merchants, applications, and/or other entities or systems that have been provided with provisioned credentials (e.g., a PAN and/or token based on the PAN). The credential request history may be generated based on records for tokens that were issued to one or more entities and/or systems. The credential request history may include a list of one or more merchants, a list of one or more devices, a list of token reference identifiers (e.g., a portion of a token and/or a unique identifier that corresponds to a token), and/or a list of one or more applications (e.g., electronic wallets, merchant applications, and/or the like) that were associated with a provisioned credential (e.g., PAN and/or token). In some non-limiting embodiments, the migration request may include the credential request history. In other non-limiting embodiments, the migration request may cause the transaction processing system 100 to query the issuer system 106 for the credential request history.

In non-limiting embodiments, in addition or alternatively to the issuer system 106 querying the issuer token vault 108 for credential data, the issuer system 106 may query the first transaction processing system 101 (the payment scheme being migrated away from, which may include the original transaction processing system and/or a token service of an original transaction processing system) to obtain credential data, including previous token requests, lists of merchants, and/or the like. In some examples, the issuer system 106 may use one or more APIs exposed by the original transaction processing system 101.

Still referring to FIG. 1, the transaction processing system 100 may generate an update request to be communicated to a merchant, application, device, and/or system to cause at least one provisioned credential to be updated based on the new account identifier (e.g., new PAN). For example, the token management system 104 may provide a new merchant token to a card-on-file merchant system 116. The token management system 104 may provide a new device token to a user device (e.g., such as a mobile device with an electronic wallet). The token management system 104 may also provide a merchant token to a card-on-file merchant system 112 that previously stored the original PAN but is moving to a token-based arrangement such that the new PAN is not stored by the merchant. In some non-limiting embodiments, an update request may include a reference to a previous credential (e.g., an old PAN or token) to allow the merchant systems 112, 116 and/or device wallet 118 to locate the previous credential to delete and/or replace it with the new credential. The device wallet 118 may be an electronic wallet on a user computing device (e.g., such as a mobile device) that has provisioned credentials (e.g., one or more tokens and/or PANs).

In some non-limiting embodiments, one or more payment gateways (not shown in FIG. 1) may hold a provisioned credential in examples where a merchant system may not store the credential because a payment gateway stores the provisioned credential on the merchant's behalf. A “card-on-file merchant,” as used herein, may refer to a merchant that directly stores a provisioned credential and/or a merchant that uses a payment gateway to store a provisioned credential for use by the merchant. In non-limiting embodiments, the token management system 104 may provide an update request to a payment gateway corresponding to a merchant.

In some non-limiting embodiments, the update request may include a portion of the new PAN (e.g., the last four digits, the first six digits or bank identification number (BIN), and/or the like). For example, the update request may include the last four digits of the new PAN such that the merchant and/or device can update a provisioned credential (e.g., a new token, the old token, the new PAN, and/or the like) to be associated with the last four digits such that the digits may be displayed to a user to select a payment device (e.g., a user choosing to transact with a payment device ending in the digits “1234”). For example, the merchant or wallet provider may have displayed the last four digits of the old PAN to the user and, after based on the update request, can display the last four digits of the new PAN for display to the user on in the wallet or merchant payment checkout page to identify that the new credential is in use. In such examples, the user will no longer see any reference of the old PAN or token.

The update request may include any other data used by a merchant system 112, 114, 116 and/or device wallet 118. In non-limiting embodiments, a card-on-file merchant 114 may be provided with the new PAN (e.g., rather than or in addition to a token) by the digital credential updating service 102 to be stored by that merchant 114. Such merchants may be provided with an option to switch to a token-based arrangement (e.g., such as merchant 112) rather than storing the PAN on file, in which case the token management system 104 may generate and communicate a new merchant token.

In non-limiting embodiments, the transaction processing system 100 may process a plurality of update requests for a plurality of merchants and/or devices in a batch. The update requests may be generated and communicated automatically (e.g., without requiring a user to take additional actions) to the merchants and/or devices (e.g., or applications executing thereon). In some non-limiting embodiments, the merchants and/or devices may be configured to receive such update requests from the transaction processing system 100. In some non-limiting embodiments, the transaction processing system 100 may generate an update request based on a protocol and/or format of the merchant and/or device being updated and may communicate the update request via an application program interface (API) exposed by the merchant and/or device. In some non-limiting embodiments, the transaction processing system 100 may expose an API for the merchants and/or devices to request an updated credential. An “application program interface” (API) refers to computer code or other data sorted on a computer-readable medium that may be executed by a processor to facilitate the interaction between software components, such as a client-side front-end and/or server-side back-end for receiving data from the client.

In non-limiting embodiments, the update request sent to merchants 112, 114, 116 and/or device wallet 118 may notify those entities that a new credential is available. For example, the update request may include a flag or some other indicator that, when received, is used to determine that a new credential is available. The update request may include the new credential(s). In some non-limiting embodiments in which the update request does not include the new credential, the entities may, in response to such a notification, generate and communicate a credential request (e.g., such as a request for a new token, a new PAN, new credential data, and/or the like) to the transaction processing system 100. The transaction processing system 100 may then provide the requested data (e.g., a new token, a new PAN, credential data, and/or the like) to the entity that requested it.

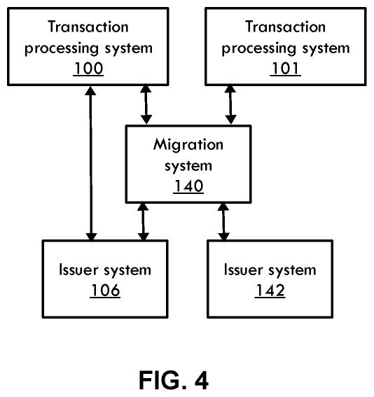

With reference to FIG. 4, a system 1004 for automatically updating credentials according to some non-limiting embodiments or aspects. In some non-limiting embodiments, a central migration system 140 may facilitate automatically updating credentials. For example, the central migration system 140 may include one or more computing devices (such as a server computer) in communication with multiple transaction processing systems 100, 101 (e.g., multiple payment networks) and multiple issuer systems 106, 142. In such examples, the central migration system 140 may expose one or more APIs to facilitate transaction processing systems 100, 101 and/or issuer systems 106, 142 to communicate. For example, a central migration system 140 may allow the transaction processing system 100 to request credential data (e.g., such as credential request history) from another transaction processing system 101. It will be appreciated that other arrangements are possible.

In some non-limiting embodiments, each transaction processing system 100, 101 (e.g., each payment network) may provide one or more interfaces (e.g., APIs and/or graphical user interfaces (GUIs) with input options) through which issuers provide information relating to the previous payment scheme being migrated from. The transaction processing system in response to such a migration request may automatically contact all systems having the old credentials (e.g., the previous PAN and/or tokens linked to the previous PAN) to cause those systems to update the old credentials to new credentials. In non-limiting embodiments, migration may be seamless to the account holders and merchants such that transactions may continue to be processed successfully during the time period that the migration occurs.

In some non-limiting embodiments, an issuer system may communicate a single command to a transaction processing system 100 to cause the credentials to be updated across multiple merchants and/or devices. In some examples, the transaction processing systems may communicate directly to request, verify, and/or cross-check the credential data needed for the migration, thereby reducing the amount of data sent by and/or requested from the issuer system.

Non-limiting embodiments may be used to update card-on-file PANs to tokens, to update card-on-file PANs to new PANs, to update card-on-file tokens to new tokens, and/or update device tokens with new tokens. In non-limiting embodiments in which the system 1000 is used to update card-on-file PANs to new PANs, the merchant (e.g., merchant 114) may request and/or obtain a list of PANs corresponding to updated PANs from the digital credential updating service 102 and may be notified of the new credential from the digital credential updating service 102. In non-limiting embodiments in which the system 1000 is used to update card-on-file tokens to new tokens, a notification may be communicated from the token management system 104 to the merchant system (e.g., merchant system 112 and/or merchant system 116). In non-limiting embodiments in which the system 1000 is used to update card-on-file PANs to tokens, and switch away from the use of PANs, an acquirer system (not shown in FIG. 1) associated with the merchant system (e.g., merchant system 112) may be provided with a token reference identifier so that it can communicate the token reference identifier to the merchant system 112 and cause the merchant system 112 to replace the on-file PAN by communicating the token reference identifier to the transaction processing system 100 (and/or token management system 104) and receive, in response to the token reference identifier, the token to store in place of the card-on-file PAN.

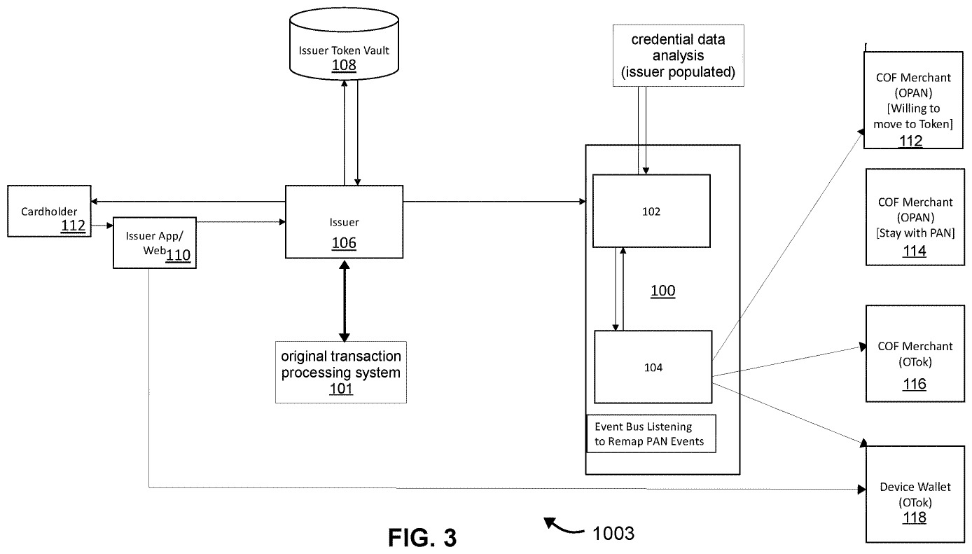

Referring now to FIG. 3, shown is another system 1003 for automatically updating credentials according to some non-limiting embodiments or aspects. In this example, the issuer application 110 and/or issuer system 106 may initiate push-based provisioning of the new credential by communicating directly (e.g., without being communicated through the transaction processing system 100) with the device wallet 118. For example, in examples in which a token is remapped to a new PAN, a notification to the device wallet 118 from the issuer application 110 and/or issuer system 106 may cause the device wallet 118 to display the last four (4) digits or some other portion of the PAN and/or token to allow a user to identify the credential. As another example in which a token is remapped to a new PAN, a notification to a merchant system (e.g., merchant system 116) may provide the last four (4) digits or some other identifier.

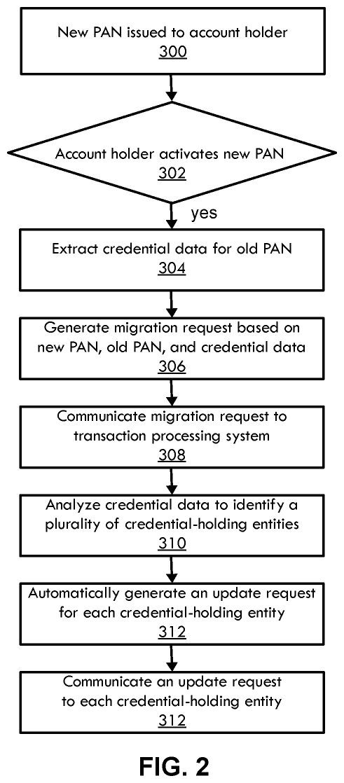

Referring now to FIG. 2, a flow diagram is shown for a method of automatically updating credentials according to non-limiting embodiments. The steps shown in FIG. 2 are for example purposes only. It will be appreciated that different, additional, fewer, and/or a different order of steps may be employed in various embodiments. At step 300, a new PAN is issued to an account holder by an issuer system. The new PAN may be associated with a new transaction processing system (e.g., a new payment network), where the account holder previously held an account (and associated payment device) through a different transaction processing system. Once a new PAN is issued, the issuer system may wait for the user to activate the new PAN through an issuer application, issuer website, and/or the like. At step 302, in response to determining that the user activated the new PAN, the method may proceed to step 304.

At step 304 of FIG. 2, the issuer system may extract credential data, such as existing tokens, token request histories, PAN request histories, credential-holding entities (e.g., merchants, applications, devices, and/or the like), from one or more databases. In some examples the issuer system may communicate with a token vault that it maintains and/or has access to. In some examples, an entity other than an issuer system may extract and/or compile the credential data. For example, a transaction processing system may extract the credential data after being provided access to any databases and/or systems storing the same. In some non-limiting embodiments, in addition or alternatively to the issuer system extracting credential data from one of its own databases, the issuer system may query the original transaction processing system (the payment scheme being migrated away from, which may include the original transaction processing system and/or a token service of an original transaction processing system) to obtain credential data, including previous token requests, lists of merchants, and/or the like. In some examples, the issuer system may use one or more APIs exposed by the original transaction processing system.

At step 306, a migration request is generated that includes the credential data, the old PAN, and the new PAN generated at step 300. The migration request may be one or more messages generated by an issuer system and communicated to a transaction processing system. It will be appreciated, however, that one or more other entities may generate and/or communicate a migration request. At step 308, the migration request is communicated to the transaction processing system.

At step 310, in response to receiving the migration request at step 308, the transaction processing system may analyze the credential data to identify a plurality of credential-holding entities. For example, if the credential data is in a formatted data structure, the transaction processing system may parse the data structure to identify each entity, such as a merchant, application, and/or device, which may hold a credential. At step 312, a batch of update requests may be automatically generated for each entity identified at step 310. The update requests may be generated based on the type of entity, such as an entity that holds a PAN, an entity that holds a merchant token (e.g., a merchant), an entity that holds a device token (e.g., an application, a device, and/or the like), and/or the like. At step 314 the update requests are communicated to the entities. In some non-limiting embodiments, steps 310-312 may be performed automatically and without user intervention in response to the migration request being received. In some examples, steps 304-312 may be performed in response to a user activating a new PAN such that the automatically updated credentials are part of the activation flow.

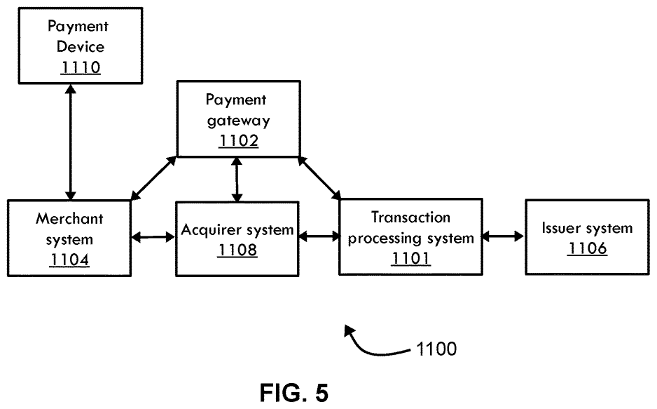

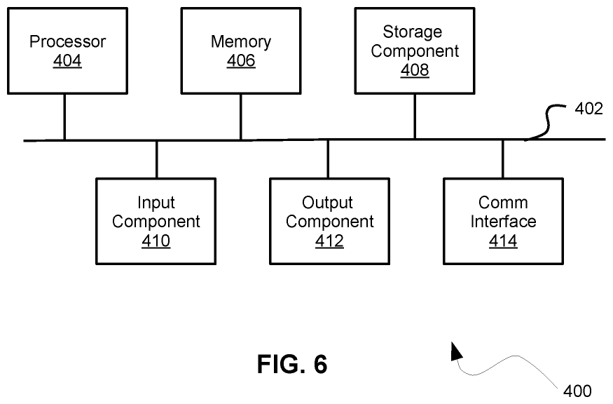

FIG. 5 shows an electronic payment processing network 1100 according to non-limiting embodiments or aspects. The payment processing network may be used in conjunction with the systems and methods described herein. It will be appreciated that the particular arrangement of electronic payment processing network 1100 shown is for example purposes only, and that various arrangements are possible. Transaction processing system 1101 (e.g., a transaction handler) is shown to be in communication with one or more issuer systems (e.g., such as issuer system 1106) and one or more acquirer systems (e.g., such as acquirer system 1108). Although only a single issuer system 1106 and single acquirer system 1108 are shown, it will be appreciated that transaction processing system 1101 may be in communication with a plurality of issuer systems and/or acquirer systems. In some embodiments, transaction processing system 1101 may also operate as an issuer system such that both transaction processing system 1101 and issuer system 1106 are a single system and/or controlled by a single entity.

In some non-limiting embodiments or aspects, transaction processing system 1101 may communicate with the merchant system 1104 directly through a public or private network connection. Additionally or alternatively, the transaction processing system 1101 may communicate with the merchant system 1104 through the payment gateway 1102 and/or acquirer system 1108. In some non-limiting embodiments or aspects, an acquirer system 1108 associated with the merchant system 1104 may operate as the payment gateway 1102 to facilitate the communication of transaction requests from the merchant system 1104 to the transaction processing system 1101. The merchant system 1104 may communicate with the payment gateway 1102 through a public or private network connection. For example, a merchant system 1104 that includes a physical POS device may communicate with the payment gateway 1102 through a public or private network to conduct card-present transactions. As another example, a merchant system 1104 that includes a server (e.g., a web server) may communicate with the payment gateway 1102 through a public or private network, such as a public Internet connection, to conduct card-not-present transactions.

In some non-limiting embodiments or aspects, the transaction processing system 1101, after receiving a transaction request from the merchant system 1104 that identifies an account identifier of a payor (e.g., such as an account holder) associated with an issued payment device 1110, may generate an authorization request message to be communicated to the issuer system 1106 that issued the payment device 1110 and/or account identifier. The issuer system 1106 may then approve or decline the authorization request and, based on the approval or denial, generate an authorization response message that is communicated to the transaction processing system 1101. The transaction processing system 1101 may communicate an approval or denial to the merchant system 1104. When the issuer system 1106 approves the authorization request message, it may then clear and settle the payment transaction between the issuer system 1106 and acquirer system 1108.

Referring now to FIG. 6, shown is a diagram of example components of a device 400 according to non-limiting embodiments or aspects. Device 400 may correspond to at least one of the computing devices (e.g., the transaction processing system 100, the issuer system 106, and/or the like) in FIG. 1. In some non-limiting embodiments or aspects, such systems or devices may include at least one device 400 and/or at least one component of device 400. The number and arrangement of components shown in FIG. 6 are provided as an example. In some non-limiting embodiments or aspects, device 400 may include additional components, fewer components, different components, or differently arranged components than those shown in FIG. 6. Additionally, or alternatively, a set of components (e.g., one or more components) of device 400 may perform one or more functions described as being performed by another set of components of device 400.

As shown in FIG. 6, device 400 may include bus 402, processor 404, memory 406, storage component 408, input component 410, output component 412, and communication interface 414. Bus 402 may include a component that permits communication among the components of device 400. In some non-limiting embodiments or aspects, processor 404 may be implemented in hardware, firmware, or a combination of hardware and software. For example, processor 404 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 406 may include random access memory (RAM), read only memory (ROM), and/or another type of dynamic or static storage device (e.g., flash memory, magnetic memory, optical memory, etc.) that stores information and/or instructions for use by processor 404.

With continued reference to FIG. 6, storage component 408 may store information and/or software related to the operation and use of device 400. For example, storage component 408 may include a hard disk (e.g., a magnetic disk, an optical disk, a magneto-optic disk, a solid state disk, etc.) and/or another type of computer-readable medium. Input component 410 may include a component that permits device 400 to receive information, such as via user input (e.g., a touch screen display, a keyboard, a keypad, a mouse, a button, a switch, a microphone, etc.). Additionally, or alternatively, input component 410 may include a sensor for sensing information (e.g., a global positioning system (GPS) component, an accelerometer, a gyroscope, an actuator, etc.). Output component 412 may include a component that provides output information from device 400 (e.g., a display, a speaker, one or more light-emitting diodes (LEDs), etc.). Communication interface 414 may include a transceiver-like component (e.g., a transceiver, a separate receiver and transmitter, etc.) that enables device 400 to communicate with other devices, such as via a wired connection, a wireless connection, or a combination of wired and wireless connections. Communication interface 414 may permit device 400 to receive information from another device and/or provide information to another device. For example, communication interface 414 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 400 may perform one or more processes described herein. Device 400 may perform these processes based on processor 404 executing software instructions stored by a computer-readable medium, such as memory 406 and/or storage component 408. A computer-readable medium may include any non-transitory memory device. A memory device includes memory space located inside of a single physical storage device or memory space spread across multiple physical storage devices. Software instructions may be read into memory 406 and/or storage component 408 from another computer-readable medium or from another device via communication interface 414. When executed, software instructions stored in memory 406 and/or storage component 408 may cause processor 404 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A system comprising at least one processor of a transaction processing system, the at least one processor programmed or configured to:
receive, from a first issuer system, a migration request identifying an original account identifier, a new account identifier, and a credential request history associated with the original account identifier, the original account identifier associated with a second transaction processing system;
analyze the credential request history to identify at least one provisioned credential associated with the original account identifier, the at least one provisioned credential comprising at least one of a card-on-file merchant credential and a device token; and
in response to identifying the at least one provisioned credential, automatically generate an update request configured to cause at least one of the following to update the at least one provisioned credential based on the new account identifier: a merchant system, a payment gateway associated with a merchant system, a user device, or any combination thereof.

2. The system of claim 1, wherein the at least one provisioned credential associated with the original account identifier comprises the at least one of a card-on-file merchant credential and the device token.

3. The system of claim 1, wherein the at least one of a card-on-file merchant credential comprises the original account identifier.

4. The system of claim 1, wherein the migration request is received via a central migration system in communication with the first issuer system, the transaction processing system, and the second transaction processing system, and wherein at least the credential request history is received by the central migration system from the first issuer system.

5. The system of claim 1, wherein the credential request history comprises at least one of the following: a token reference identifier, token requestor data, a merchant identifier associated with the original account identifier, or any combination thereof.

6. The system of claim 1, wherein account data associated with the device token comprises a new token.

7. The system of claim 1, wherein account data associated with the at least one provisioned credential comprises at least one of the following: a subset of digits of the new account identifier, a token corresponding to the new account identifier, the new account identifier, or any combination thereof.

8. The system of claim 1, wherein the at least one provisioned credential associated with the original account identifier comprises the at least one of a card-on-file merchant credential and the device token, and wherein automatically generating the update request in response to identifying the at least one provisioned credential comprises:
in response to identifying the at least one of a card-on-file merchant credential, automatically generating a merchant update request configured to cause the merchant system for the card-on-file merchant and/or the payment gateway for the card-on-file merchant to update account data associated with the provisioned credential and stored by the merchant system or the payment gateway of the card-on-file merchant; and
in response to identifying the device token, automatically generating a device update request configured to cause a user device to update account data associated with the device token and stored by the user device.

9. A computer-implemented method comprising:
receiving, with at least one processor of a transaction processing system from a first issuer system, a migration request identifying an original account identifier, a new account identifier, and a credential request history associated with the original account identifier, the original account identifier associated with a second transaction processing system;
analyzing, with the at least one processor, the credential request history to identify at least one provisioned credential associated with the original account identifier, the at least one provisioned credential comprising at least one of a card-on-file merchant credential and a device token; and
in response to identifying the at least one provisioned credential, automatically generating an update request configured to cause at least one of the following to update the at least one provisioned credential based on the new account identifier: a merchant system, a payment gateway associated with a merchant system, a user device, or any combination thereof.

10. The computer-implemented method of claim 9, wherein the at least one provisioned credential associated with the original account identifier comprises the at least one of a card-on-file merchant credential and the device token.

11. The computer-implemented method of claim 9, wherein the at least one of a card-on-file merchant credential comprises the original account identifier.

12. The computer-implemented method of claim 9, wherein the migration request is received via a central migration system in communication with the first issuer system, the transaction processing system, and the second transaction processing system, and wherein at least the credential request history is received by the central migration system from the first issuer system.

13. The computer-implemented method of claim 9, wherein the credential request history comprises at least one of the following: a token reference identifier, token requestor data, a merchant identifier associated with the original account identifier, or any combination thereof.

14. The computer-implemented method of claim 9, wherein account data associated with the device token comprises a new token.

15. The computer-implemented method of claim 9, wherein account data associated with the at least one provisioned credential comprises at least one of the following: a subset of digits of the new account identifier, a token corresponding to the new account identifier, the new account identifier, or any combination thereof.

16. The computer-implemented method of claim 9, wherein the at least one provisioned credential associated with the original account identifier comprises the at least one of a card-on-file merchant credential and the device token, and wherein automatically generating the update request in response to identifying the at least one provisioned credential comprises:
in response to identifying the at least one of a card-on-file merchant credential, automatically generating a merchant update request configured to cause the merchant system or payment gateway associated with the card-on-file merchant to update account data associated with the provisioned credential and stored by the merchant system or payment gateway of the card-on-file merchant; and
in response to identifying the device token, automatically generating a device update request configured to cause a user device to update account data associated with the device token and stored by the user device.

17. A computer-implemented method comprising:
receiving, with at least one processor of a transaction processing system from a first issuer system, a migration request identifying an original account identifier, a new account identifier, and a credential request history associated with the original account identifier, the original account identifier associated with a second transaction processing system;
analyzing, with the at least one processor, the credential request history to identify at least one provisioned credential of a card-on-file merchant and at least one device token associated with the original account identifier;
in response to identifying the provisioned credential of at least one card-on-file merchant, automatically generating a merchant update request configured to cause the card-on-file merchant to update account data associated with the provisioned credential and stored by a merchant system of the card-on-file merchant; and
in response to identifying the at least one device token, automatically generating a device update request configured to cause a user device to update account data associated with the at least one device token and stored by the user device.

18. A computer program product comprising at least one non-transitory computer-readable medium including program instructions that, when executed by at least one processor of a transaction processing system, causes the at least one processor to:
receive, from a first issuer system, a migration request identifying an original account identifier, a new account identifier, and a credential request history associated with the original account identifier, the original account identifier associated with a second transaction processing system;
analyze the credential request history to identify at least one provisioned credential associated with the original account identifier, the at least one provisioned credential comprising at least one of a card-on-file merchant credential and a device token; and
in response to identifying the at least one provisioned credential, automatically generate an update request configured to cause at least one of the following to update the at least one provisioned credential based on the new account identifier: a merchant system, a payment gateway associated with a merchant system, a user device, or any combination thereof.
